(19) United States
(12) Patent Application Publication
(10) Pub. No.: US 2024/0239004 A1
(43) Pub. Date: Jul. 18, 2024

(54) WOOD MATERIALS HAVING ANISOTROPIC ELASTICITY, AND METHODS FOR FABRICATION AND USE THEREOF

(71) Applicant: UNIVERSITY OF MARYLAND, COLLEGE PARK, College Park, MD (US)

(72) Inventors: Liangbing HU, Rockville, MD (US); Xinpeng ZHAO, Berwyn Heights, MD (US); Yu LIU, Berwyn Heights, MD (US)

(21) Appl. No.: 18/563,562

(22) PCT Filed: May 27, 2022
(86) PCT No.: PCT/US22/31289

§ 371 Date: Nov. 22, 2023

Related U.S. Application Data
(60) Provisional application No. 63/194,925, filed on May 28, 2021.

(51) Int. Cl. B27K 5/06; A43B 1/06; B27K 3/02; B27K 3/34

(52) U.S. Cl. CPC B27K 5/06; A43B 1/06; B27K 3/0221; B27K 3/34; B27K 2240/10

(57) ABSTRACT

A piece of natural wood can be immersed in a first solution at a first temperature less than 100° C. and then immersed in a second solution at a second temperature greater than 100° C. so as to form a piece of partially-delignified wood. In some embodiments, the first and second solutions can be the same solution, and the immersion at the second temperature can be heating the solution from the first temperature to the second temperature. The immersion in the first and second solutions can be effective to remove 45-90% of lignin from the piece of natural wood and to destroy a structure of the ray cells in the piece of natural wood while retaining cell walls of the other cells. The partially-delignified wood can then be dried. After drying, the partially-delignified wood can be clastic along its tangential direction but inelastic along its radial and longitudinal directions.

### CROSS-REFERENCE TO RELATED APPLICATION(S)

The present application claims the benefit of U.S. Provisional Application No. 63/194,925, filed May 28, 2021, entitled “Spongy Wood Materials and Methods of Making and Using the Same,” which is incorporated by reference herein in its entirety.

### STATEMENT REGARDING FEDERALLY SPONSORED RESEARCH

This invention was made with government support under DESC0018820 awarded by the Department of Energy (DOE). The government has certain rights in the invention.

### FIELD

The present disclosure relates generally to wood materials and wood processing, and more particularly, to elastic wood and wood composites.

### BACKGROUND

Spongy materials, including inorganics (e.g., carbon materials, metals, oxides), polymers, and biological materials (e.g., cellulose), have been fabricated from biomasses, such as bacterial cellulose, nanocellulose, and natural wood. For example, cellulose nanofibers (CNFs) extracted from cell walls of plants have been used as building blocks for spongy materials. The bottom-up fabrication process to form spongy materials from CNFs generally involves multiple steps. First, chemical, enzymatic, and/or mechanical treatments are used to extract CNFs from plants. The extracted CNFs are then dispersed into solution, before being reconstructed into aerogels. However, this bottom-up approach requires substantial amounts of both time and energy, which can limit its utility and/or scalability. Moreover, such spongy materials exhibit low compressive strength (e.g., <0.1 MPa) due to weak bonding of interconnected interfaces. Embodiments of the disclosed subject matter may address one or more of the above-noted problems and disadvantages, among other things.

### SUMMARY

Embodiments of the disclosed subject matter system provide a dry, spongy wood material (or wood composite) that exhibits anisotropic elasticity, as well as methods for making or use thereof. In some embodiments, the spongy wood material can have a wave-like microstructure derived from natural wood. For example, the spongy wood material can be formed by partial delignification of natural wood, which can remove ray cells in the native microstructure of the wood while retaining cell walls of the longitudinally-extending wood cells. In some embodiments, 45-90% of the native lignin in the natural wood can be removed by subjecting to one or more chemical treatments, for example, using an alkaline solution at a temperature greater than 100° C. After partial delignification, the wood can be dried such that the lumen of the longitudinally-extending cells remain open. The resulting dried wood can exhibit high-mechanical strength (e.g., >0.1 MPa) and anisotropic elasticity. For example, in some embodiments, the dried, partially-delignified wood can be elastic along the tangential direction of the wood but inelastic along the radial and longitudinal directions of the wood.

In one or more embodiments, a method can comprise providing a piece of natural wood having a longitudinal direction, a radial direction, and a tangential direction. The natural wood can have a microstructure with lumina formed by cell walls of (i) vessels and wood fiber cells or (ii) tracheids. Each of the lumina can have an axis that extends along the longitudinal direction. The natural wood can further have ray cells. Each ray cell can have an axis that extends along the radial direction. The tangential direction can be perpendicular to the longitudinal and radial directions. The method can further comprise immersing at least part of the piece of natural wood in a first solution at a first temperature for a first time. The first temperature can be less than 100° ° C. The method can also comprise immersing the at least part of the piece of natural wood in a second solution at a second temperature for a second time so as to form a piece of partially-delignified wood. The second temperature can be greater than 100° C. The immersing can be effective to remove between 45% and 90%, inclusive, of lignin from the piece of natural wood and can destroy a structure of the ray cells in the piece of natural wood while retaining the lumina formed by the cell walls. The method can further comprise drying the piece of partially-delignified wood such that the lumina remain open. After the drying, the piece of partially-delignified wood can be substantially elastic along the tangential direction and substantially inelastic along the radial and longitudinal directions.

In one or more embodiments, a wood structure can comprise a piece of partially-delignified wood that retains lumina formed by cell walls of (i) vessels and wood fiber cells or (ii) tracheids from an original natural wood but lacks ray cells from the original natural wood. Each of the lumina can have an axis that extends along a longitudinal direction of the natural wood. Each ray cell can have an axis that extends along a radial direction of the natural wood. A tangential direction of the natural wood can be perpendicular to the longitudinal and radial directions. The piece of partially-delignified wood can be substantially elastic along the tangential direction and substantially inelastic along the radial and longitudinal directions.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 illustrates macroscale and microscale features of natural wood that can be exploited to form a wood material having anisotropic elasticity, according to one or more embodiments of the disclosed subject matter.

FIGS. 2A and 3A are simplified schematic diagrams showing a cross-section in the radial-tangential plane of natural wood and a partially-delignified wood having anisotropic elasticity, respectively, according to one or more embodiments of the disclosed subject matter.

FIGS. 2B and 3B are scanning electron microscopy (SEM) images of a cross-section in the radial-tangential plane of natural wood and partially-delignified wood (medium balsa wood having a density of 0.17 g/cm³) having anisotropic elasticity, respectively, according to one or more embodiments of the disclosed subject matter.

FIGS. 2C and 3C are SEM images of a cross-section in the longitudinal-tangential plane of the natural wood and partially-delignified wood of FIGS. 2B and 3B, respectively, according to one or more embodiments of the disclosed subject matter.

FIGS. 2D and 3D are magnified SEM images of a cross-section in the radial-tangential plane of the natural wood and partially-delignified wood of FIGS. 2B and 3B, respectively, showing a region of ray cells, according to one or more embodiments of the disclosed subject matter.

FIGS. 2E and 3E are magnified SEM images of a cross-section in the radial-tangential plane of natural wood and partially-delignified wood of FIGS. 2B and 3B, respectively, showing a region of wood fiber cells, according to one or more embodiments of the disclosed subject matter.

FIG. 4 is a process flow diagram of a method for fabricating wood materials having anisotropic elasticity, according to one or more embodiments of the disclosed subject matter.

FIG. 5A is a graph of compressive stress versus strain for fabricated wood having anisotropic elasticity.

FIG. 5B is a graph of compressive strength for fabricated wood pieces with different lignin removal percentages.

FIG. 6A shows compression cycling of a fabricated wood piece having anisotropic elasticity.

FIG. 6B shows magnified views of the fabricated wood piece during respective stages of the compression cycling of FIG. 6A.

FIG. 7 is a graph of compressive stress versus strain for wood pieces fabricated using different delignification conditions.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

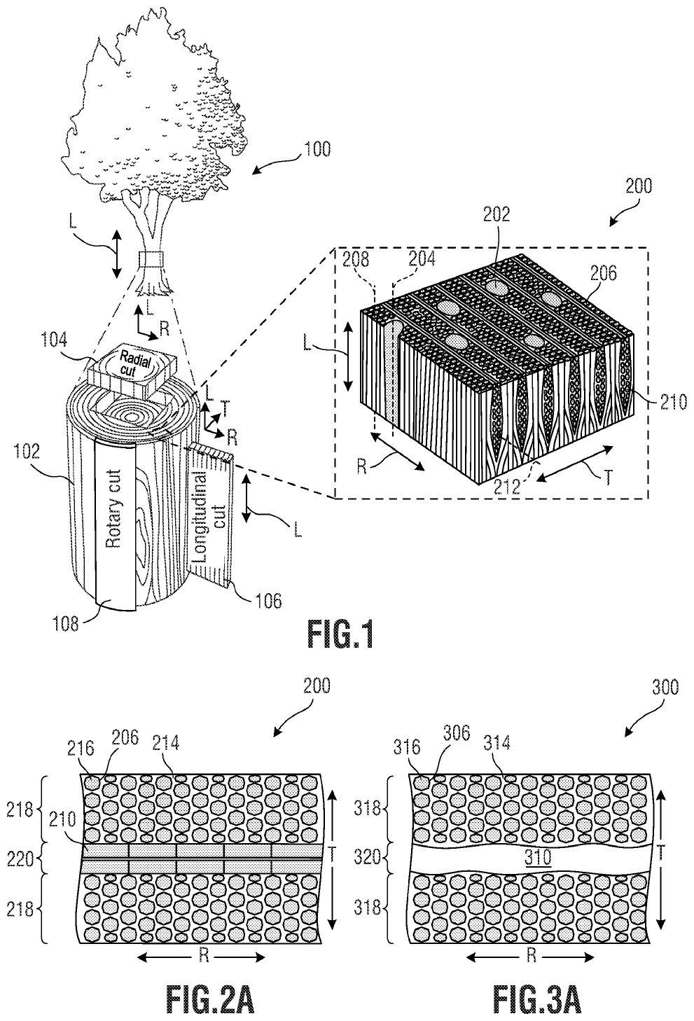

Longitudinal direction (L): A direction along which a tree grows from its roots or from a trunk thereof (e.g., direction L for trunk 102 from tree 100 in FIG. 1). Cellulose nanofibers forming cell walls of wood fiber cells, vessels, and/or tracheids may generally be aligned with the longitudinal direction. In some cases, the longitudinal direction for the native wood may be generally vertical and/or correspond to a direction of the wood's water transpiration stream from roots of the tree. The longitudinal direction is perpendicular to the radial and tangential directions of the wood.

Radial direction (R): A direction that extends from a center portion of the tree outward (e.g., direction R for trunk 102 from tree 100 in FIG. 1). In some embodiments, ray cells of the wood can extend along the radiation direction. In some cases, the radial direction for the native wood may be generally horizontal. The radial direction is perpendicular to the longitudinal and tangential directions of the wood.

Tangential direction (T) or circumferential direction: A direction perpendicular to both the longitudinal and radial directions in a particular cut of wood (e.g., direction T for trunk 102 from tree 100 in FIG. 1). In some cases, the tangential direction for the native wood may be generally horizontal. In some embodiments, the tangential direction can follow a growth ring of the wood.

Partial Delignification: The removal of some but not all of naturally-occurring lignin from natural wood, for example, removing 45-90% of lignin (e.g., on a weight percent basis). In some embodiments, the lignin content after delignification can be in a range of 2-16.5 wt % for hardwood or in a range of 1.5-19.2 wt % for softwood. Lignin content within the wood before and after delignification can be assessed using known techniques in the art, for example, Laboratory Analytical Procedure (LAP) TP-510-42618 for “Determination of Structural Carbohydrates and Lignin in Biomass,” Version 08-03-2012, published by National Renewable Energy Laboratory (NREL), and ASTM E1758-01(2020) for “Standard Test Method for Determination of Carbohydrates in Biomass by High Performance Liquid Chromatography,” published by ASTM International, both of which are incorporated herein by reference.

Moisture content: The amount of fluid, typically water, retained within the microstructure of the wood. In some embodiments, the moisture content (MC) can be determined by oven-dry testing, for example by calculating the change in weight achieved by oven drying (e.g., at 103° C. for 6 hours) the wood, using the equation:

$$MC ( \% ) = \frac{weiqht before dry - weight after dry}{weight after dry} \times 100.$$

Alternatively or additionally, moisture content can be assessed using known techniques in the art, for example, an electrical moisture meter or other techniques disclosed in ASTM D4442-20 (2020) for “Standard Test Methods for Direct Moisture Content Measurement of Wood and Wood-based Materials,” published by ASTM International, which standard is incorporated herein by reference.

Elasticity: Ability of a wood material (consisting essentially of wood, wood with one or more coatings, or a composite of wood filled with a polymer) to resist a compressive force and to return to its original shape and size when that force is removed. In some embodiments, the wood material is substantially elastic along the tangential direction only, while being substantially inelastic along the radial and longitudinal directions.

### INTRODUCTION

A spongy wood material can be formed by partial delignification of natural wood. In some embodiments, 45-90% of the native lignin in the natural wood can be removed by subjecting the wood to one or more chemical treatments, for example, one or more alkaline solutions at a temperature less than 100° C. for a first duration and one or more alkaline solutions at a temperature greater than 100° C. for a second duration. In some embodiments, the partial delignification can selectively disrupt, destroy, or otherwise remove radially-extending ray cells in the native microstructure of the wood while retaining cell walls of the longitudinally-extending wood cells (e.g., vessels, wood fiber, tracheids). The partially-delignified wood can be dried such that the lumen of the longitudinally-extending wood cells remain open. The resulting spongy wood can exhibit high-mechanical strength (e.g., >0.1 MPa, such as 0.1-1.5 MPa at 60% compression) and anisotropic elasticity. For example, in some embodiments, the spongy wood can be clastic along the tangential direction of the wood but inelastic along the radial and longitudinal directions of the wood. Alternatively or additionally, the modulus of elasticity of the spongy wood along its tangential direction can be at least an order of magnitude less than that along the radial and longitudinal directions.

Microstructures of Natural Wood and Wood with Anisotropic Elasticity

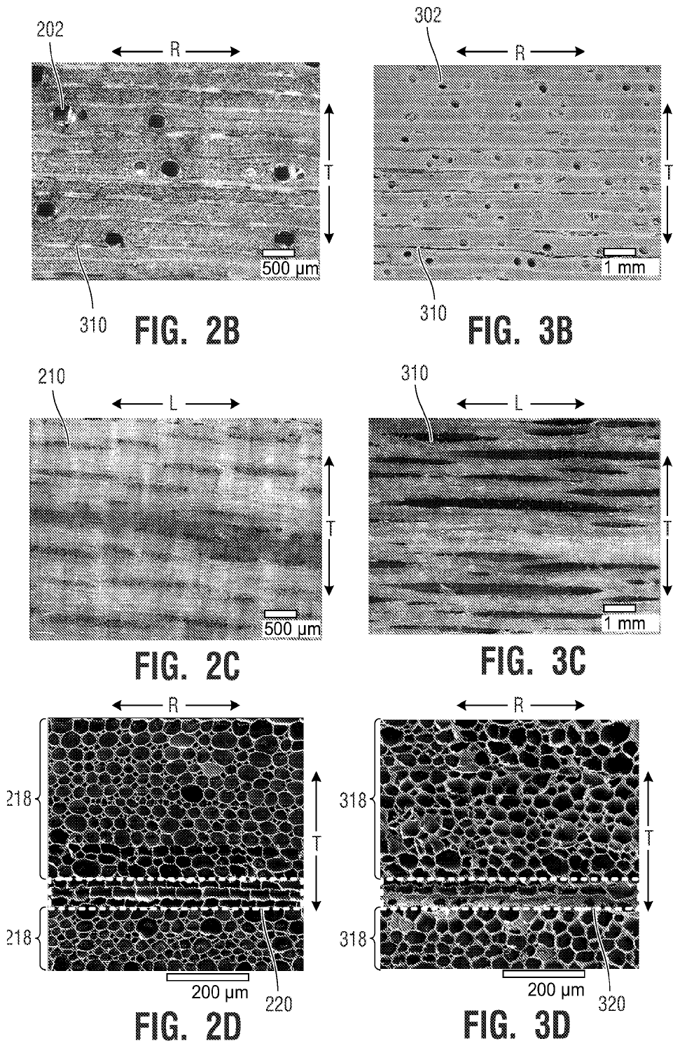

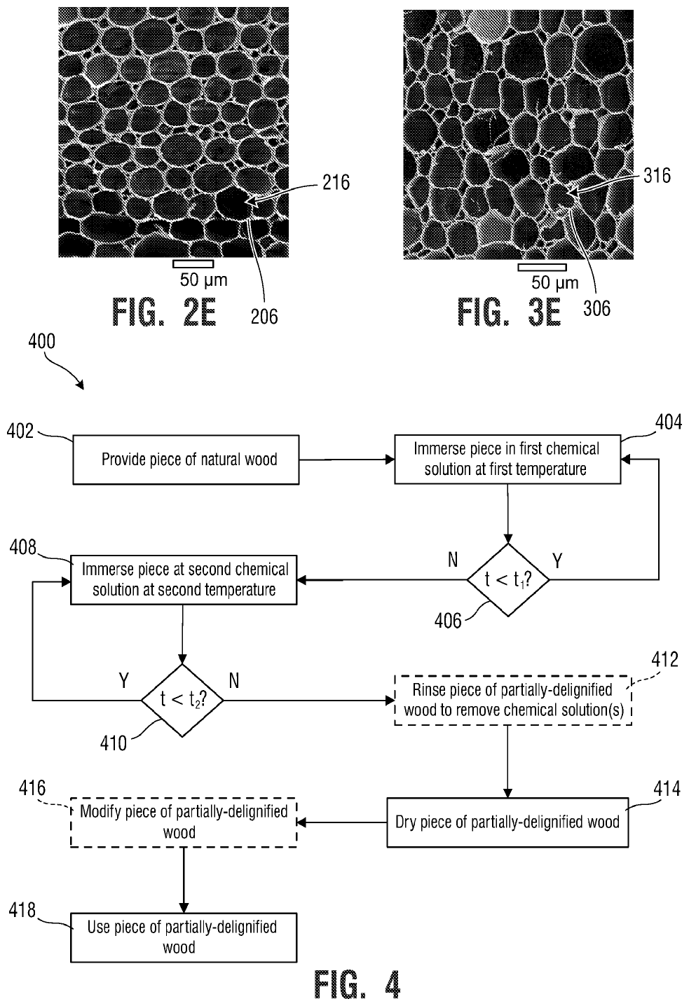

Natural wood has a unique three-dimensional porous microstructure comprising and/or defined by various interconnected cells. For example, FIGS. 1-2E illustrate a hardwood microstructure 200 where vessels 202 are disposed within a hexagonal array of wood fiber cells 206 in a longitudinally-extending cell region 218. The vessels and fiber cells within region 218 extend along the longitudinal direction, L, of the wood. Thus, the lumen of each vessel 202 can have an extension axis 204 that is substantially parallel to the longitudinal direction, L, and the lumen 216 of each fiber cell 206 can have an extension axis 208 that is substantially parallel to the longitudinal direction, L. Arranged between adjacent regions 218 along tangential direction, T, is a radially-extending cell region 220, where a plurality of ray cells 210 are disposed. The ray cells within region 220 extend along radial direction, R, of the wood. Thus, the lumen of each ray cell 210 can have an extension axis 212 that is substantially parallel to the radial direction, R, of the wood. An intracellular lamella 214 is disposed between the vessels 202, fiber cells 206, and ray cells 210, and serves to interconnect the cells together. Softwoods can have a similar microstructure structure as that of hardwood, but with the vessels and wood fibers being replaced by tracheids that extend in the longitudinal direction, L, of the wood.

In some embodiments, the natural wood can be partially-delignified, for example, to modify the microstructure thereof. For example, the partial delignification can remove at least 45% but no more than 90% of the native lignin of the wood. Moreover, by carefully controlling the chemical treatment of the partial delignification, the ray cells 210 in the wood structure can be selectively destroyed, while the longitudinally-extending cells (e.g., vessels 202 and wood fiber cells 206) are substantially retained. In addition, the partial delignification can retain at least some of the lamella 214, such that at least some parts of adjacent cell walls remain connected. For example, as shown in FIGS. 3A-3E, the microstructure 300 of the partially-delignified wood can exhibit a void in radially-extending cell region 320, corresponding to cell region 220 in FIG. 2A where ray cells 210 were previously disposed. Meanwhile, the partial delignification can leave the configurations of vessels and fiber cells in the longitudinally-extending cell regions 318 substantially unchanged, albeit with a reduced lignin content. For example, after the partial-delignification, partially-delignified fiber cell 306 defining lumen 316 (corresponding to cell region 218 in FIG. 2A) can have a similar cross-sectional shape (e.g., maximum cross-sectional dimension, or diameter, substantially the same as that of the fiber cell prior to delignification), as shown in FIGS. 3A-3E.

The preserved walls of the longitudinally-extending cells (e.g., vessels 302, fiber cells 306), along with the partially-delignified lamella 314 at least partially interconnecting the retained cells, can provide the processed wood with improved mechanical strength (as compared to fully delignified wood). At the same time, the voids 310 introduced by selective removal of ray cells 210, together with the increased flexibility of the remaining cell walls introduced by partial delignification, can enhance the elasticity of the processed wood along the tangential direction, T. As shown in FIGS. 3D-3E, the processed wood retains the honeycomb structure (e.g., hexagonal arrangement) of the natural wood, which can allow the wood to stretch or bend under an external load and return to its original shape after removal of the load without breakage. However, since the longitudinally-extending cells are retained, the processed wood may remain inelastic along the longitudinal and radial directions. Alternatively or additionally, a modulus of elasticity of the processed wood along the tangential direction can be at least an order of magnitude less than that along the radial direction and/or that along the longitudinal direction. Thus, the partial delignification can be effective to imbue the resulting wood with anisotropic elasticity while preserving high mechanical strength (e.g., by retaining cellulose and at least some native lignin).

The cut direction of the original piece of wood can dictate the orientation of the cell lumina in the final structure, which orientation in turn will dictate the direction of elasticity (e.g., only along the tangential direction) in the final structure. For example, in some embodiments, a piece of natural wood can be cut from a trunk 102 of tree 100 in a vertical or longitudinal direction (e.g., parallel to longitudinal wood growth direction, L) such that lumina of longitudinally-extending cells are oriented substantially parallel to a major face (e.g., largest surface area) of the longitudinal-cut wood piece 106. In the longitudinal-cut wood piece 106, the tangential direction, T, and thus the direction of elasticity, can be substantially perpendicular to the major face. Alternatively, in some embodiments, the piece of natural wood can be cut in a horizontal or radial direction (e.g., perpendicular to longitudinal wood growth direction, L) such that lumina of longitudinally-extending cells are oriented substantially perpendicular to the major face of the horizontal-cut wood piece 104. In the longitudinal-cut wood piece 104, the tangential direction, T, and thus the direction of elasticity, can be substantially parallel to growth rings within the cut. Alternatively, in some embodiments, the piece of natural wood can be cut in a rotation direction (e.g., perpendicular to the longitudinal wood growth direction L and along a circumferential direction of the trunk 102) such that lumina of longitudinal cells are oriented substantially parallel to the major face of the rotary-cut wood piece 108. In the rotary-cut wood piece 108, the tangential direction, T, and thus the direction of elasticity, can be substantially parallel to the major face of the rotary-cut wood piece 108. In some embodiments, the piece of natural wood can be cut at any other orientation between longitudinal, radial, and rotary cuts.

### Elastic Wood Composites

In some embodiments, the elastic wood can be combined with other materials to form a composite structure. For example, the elastic wood can be subjected to a functional treatment. In some embodiments, after the functional treatment, the elastic wood can retain its porous nature (e.g., porosity of at least 50%) and high strength (e.g., ≥0.1 MPa in compression). For example, the functional treatment can include applying a coating (e.g., ≤10 μm thick) to external surfaces and/or internal surfaces of the porous matrix of the elastic wood or coupling particles (e.g., nanoparticles, having a maximum cross-sectional dimension or diameter of 100 nm or less) to the external surfaces and/or internal surfaces of the clastic wood. Such functional treatments can include, but are not limited to, spin-coating, in-situ growth, dip-coating, spray-coating, chemical vapor deposition, physical vapor deposition, atomic layer deposition, sputter-coating, and immersed growth.

In some embodiments, the coating or the coupled particles can include a conductive material, a semi-conductive material, and/or an insulating material. For example, the coating or the coupled particles can include, but are not limited to, nanoparticles, nanowires, graphene, graphite, ceramic oxide, carbon nanotubes (CNTs) (e.g., single-walled CNTs, double-walled CNTs, multi-walled CNTs, etc.), polyaniline, carbon black, and combinations thereof. Alternatively or additionally, the coating or the coupled particles can be hydrophobic materials, weather-resistant materials, and/or water-resistant materials. For example, the coating or the coupled particles can include, but are not limited to, manganese oxide polystyrene (MnO₂/PS) nano-composite, zinc oxide polystyrene (ZnO/PS) nano-composite, precipitated calcium carbonate, carbon nano-tube structures, silica nano-coating, fluorinated silanes, polyethylene (PE), polystyrene (PS), polyvinylchloride (PVC), polytetrafluorethylene (PTFE), polydimethylsiloxane (PDMS), polyester, polyurethane, poly(methyl methacrylate) (PMMA), polyepoxide (e.g., epoxy resin), and combinations thereof.

Alternatively or additionally, the coating or the coupled particles can be anti-bacterial salt and/or metal particles. For example, the coating or the coupled particles can include, but are not limited to, sodium chloride, potassium sulphate, sodium sulphate, calcium sulphate, magnesium sulphate, copper sulphate, sodium nitrate, sodium carbonate, calcium, silicon, phosphorus, silver nanoparticles, titanium oxide nanoparticles, and combinations thereof. Alternatively or additionally, the coating or the coupled particles can be a solar or radiation absorptive material. For example, the coating or the coupled particles can include, but are not limited to, CNTs, carbon black, graphite, hard carbon, reduced graphene oxide, graphene, and combinations thereof.

Alternatively or additionally, the coating or the coupled particles can be plasmonic metallic nanoparticles, catalytic nanoparticles, and/or electroactive nanoparticles. Examples of materials for the plasmonic metallic nanoparticles include but are not limited to Au, Pt, Ag, Pd, and Ru. Alternatively or additionally, the coating or the coupled particles can be metallic nanoparticles, metal alloy nanoparticles, semiconductor nanoparticles, sulfides, phosphides, borides, oxides, or any combination thereof. For example, the metallic nanoparticles and the metal alloy nanoparticles can include, but are not limited to, Pt, Pd, Au, Ag, Ni, Co, Ru, and Fe. Examples of materials for the semiconductor nanoparticles can include CuFeSe, or any other semiconductor. Examples of materials for the sulfides can include, but are not limited to, MoS₂, FeS₂, and CoSₓ where x is an integer. Examples of materials for the phosphides include, but are not limited to, COP, NiP₂, and MoPₓ where x is an integer. Examples of materials for the borides include, but are not limited to, COB, MoB, and NiB. Examples of materials for the oxides include, but are not limited to, MnO₂, Fe₂O₃, CoO, and NiO.

Alternatively or additionally, in some embodiments, an elastic wood composite can be formed by filling the open lumina and/or pores of the elastic wood microstructure with an elastic polymer (or polymer precursor) and/or an elastic protein. In some embodiments, after the filling, the wood composite can have a reduced porosity (e.g., porosity≤10%) and high strength (e.g., ≥0.1 MPa in compression). In addition, the wood composite can remain highly elastic (e.g., at least along the tangential direction) in addition to other beneficial mechanical properties (e.g., high tear resistance, high tensile strength, resilience, abrasion resistance, friction resistance, etc.).

For example, the porous matrix of the elastic wood can be filled with natural or synthetic polyisoprene, polybutadiene, chloroprene rubber (e.g., Baypren®), polychloroprene, neoprene, butyl rubber, halogenated butyl rubber, styrene-butadiene rubber (e.g., copolymer of styrene and butadiene), polydimethylsiloxane (PDMS), nitrile rubber (e.g., copolymer of butadiene and acrylonitrile), hydrogenated nitrile rubber (e.g., Therban®, Zetpol®, etc.), ethylene propylene rubber (e.g., a copolymer of ethene and propene), ethylene propylene diene monomer (EPDM) rubber, epichlorohydrin rubber, polyacrylic rubber, silicon rubber, fluorosilicone rubber, fluoroelastomer (e.g., Viton™, Tecnoflon®, Fluorel™, AFLAS®, DAI-EL™), perfluoroelastomer (e.g., Tecnoflon® PFR, Kalrez®, Chemraz®, Perlast®), polyether block amide, chlorosulfonated polyethylene (e.g., Hypalon®), ethylene-vinyl acetate, thermoplastic elastomer, resilin, elastin, polysulfide rubber, elastolefin, poly(dichlorophosphazene), an inorganic rubber from hexachlorophosphazene polymerization, or any combination thereof.

### Methods for Making Elastic Wood Structures

FIG. 4 shows a generalized method 400 for fabricating a wood material with anisotropic elasticity. The method 400 can initiate at process block 402, where a piece of natural wood is provided. For example, the natural wood can be any type of hardwood or softwood, such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir, hemlock, larch, pine, redwood, spruce, tamarack, juniper, and yew. In some embodiments, the providing of process block 402 can also include cutting, removing, or otherwise separating the piece of natural wood from a parent tree. For example, in some embodiments, the cutting can form the wood into any one-dimensional (e.g., an elongated structure, where a thickness and a width are both at least an order of magnitude less than its length), two-dimensional (e.g., a substantially flat planar structure, where a thickness is at least an order of magnitude less than its length and width), or three-dimensional (e.g., a block, where a thickness, width, and length are all within an order of magnitude of each other) structure. In some embodiments, the piece of natural wood can be provided (and/or formed) such that a tangential direction of the wood is substantially parallel to a direction of desired elasticity.

The method 400 can proceed to process block 404, where the piece of natural wood is subjected to one or more first chemical treatments. In some embodiments, each first chemical treatment comprises partially or fully immersing the piece of natural wood in a first chemical solution at a first temperature. Alternatively or additionally, each first chemical treatment or at least one first chemical treatment can comprise infusing, infiltrating, or otherwise exposing the piece of natural wood to the first chemical solution at the first temperature. In some embodiments, the first chemical solution can be an alkaline solution, and the first temperature can be less than 100° C. For example, the first temperature can be in a range of 5-95° C., inclusive, such as room temperature (e.g., ˜23° C.).

In some embodiments, each first chemical treatment or only some first chemical treatments can be performed under vacuum, such that the first chemical solution associated with the treatment is encouraged to fully penetrate the microstructure of the piece of wood.

Alternatively, in some embodiments, the first chemical treatment(s) can be performed under ambient pressure conditions or elevated pressure conditions (e.g., ˜6-8 bar). In some embodiments, the first chemical solution is not agitated in order to minimize the amount of disruption to the microstructure of the natural wood.

The method 400 can proceed to decision block 406, where it is determined if a predetermined first duration, t₁, for the first chemical treatment has been reached. The time, t, can be measured from a start of the respective first chemical treatment, for example, once the piece of natural wood is immersed in the first chemical solution. In some embodiments, the first duration may be greater than or equal to 8 hours, for example, ˜24 hours. If the first duration has not been reached (e.g., t<t₁), the method 400 can return to process block 404 to continue the first chemical treatment (e.g., by continuing the immersion of the piece of wood in the first chemical solution at the first temperature) or by re-performing the first chemical treatment (e.g., by immersing the piece of wood in another first chemical solution). If the first duration has been reached (e.g., t≥t₁), the method 400 can proceed from decision block 406 to process block 408.

At process block 408, the piece of wood is subjected to one or more second chemical treatments. In some embodiments, each second chemical treatment comprises partially or fully immersing the piece of natural wood in a second chemical solution at a second temperature greater than the first temperature. Alternatively or additionally, each second chemical treatment or at least one second chemical treatment can comprise infusing, infiltrating, or otherwise exposing the piece of wood to the second chemical solution at the second temperature. In some embodiments, the second chemical solution can be an alkaline solution, and the second temperature can be greater than 100° C. For example, the second temperature can be in a range of 120-180° C.

In some embodiments, the second chemical solution may be the same solution used in process block 404. In such cases, process block 408 can comprise heating the first chemical solution from the first temperature to the second temperature while the piece of wood remains therein. Alternatively, in some embodiments, a composition of the second chemical solution can be identical to a composition of the first chemical solution, for example, by providing a fresh batch of solution for use as the second chemical solution (e.g., by removing the wood piece from the first chemical solution and immersing in the second chemical solution, or by draining the first chemical solution and replacing with fresh second chemical solution). Alternatively, in some embodiments, a composition of the second chemical solution can be different from the composition of the first chemical solution.

The first chemical solution, the second chemical solution, or both the first and second chemical solutions can comprise, for example, sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), or any combination of the above. Exemplary combinations of chemicals can include, but are not limited to, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, NaOH+O₂, H₂O₂+NaClO, and NaClO₂+acetic acid. For example, the first and second chemical solutions can be 2.5-5.0 wt % NaOH.

In some embodiments, each second chemical treatment or only some second chemical treatments can be performed under vacuum, such that the second chemical solution associated with the treatment is encouraged to fully penetrate the microstructure of the piece of wood. Alternatively, in some embodiments, the second chemical treatment(s) can be performed under ambient pressure conditions or elevated pressure conditions (e.g., ˜ 6-8 bar). In some embodiments, the second chemical solution is not agitated in order to minimize the amount of disruption to the microstructure of the wood.

The method 400 can proceed to decision block 410, where it is determined if a predetermined second duration, t₂, for the second chemical treatment has been reached. The time, t, can be measured from a start of the respective second chemical treatment (as opposed to the start of the first chemical treatment), for example, once the piece of wood is immersed in the second chemical solution. In some embodiments, the second duration may be less than or equal to 10 hours, for example, in a range of 0.1-5 hours. If the second duration has not been reached (e.g., t<t₂), the method 400 can return to process block 408 to continue the second chemical treatment (e.g., by continuing the immersion of the piece of wood in the second chemical solution at the second temperature) or by re-performing the second chemical treatment (e.g., by immersing the piece of wood in another second chemical solution).

In some embodiments, the durations t₁, t₂ can be selected such that the combination of the first and second chemical treatments removes at least some, but not all, of the native lignin in the wood piece. For example, the lignin content can be reduced to between 45% (lignin content is 45% of original lignin content in the natural wood) and 90% (lignin content is 90% of original lignin content in the natural wood), depending upon the desired application. In some embodiments, 60-90% of the original lignin can be removed by the first and second chemical treatments. In some embodiments, when the natural wood is hardwood, the lignin content once the duration t₂ has been reached can be in a range of 2-16.5 wt %. In some embodiments, when the natural wood is softwood, the lignin content once the duration t₂ has been reached can be in a range of 2.5-19.2 wt %. In addition to the lignin removal, the combination of the first and second chemical treatments can be effective to selectively remove the radially-extending ray cells of the natural wood microstructure, while substantially retaining the cell walls of the longitudinally-extending cells (e.g., vessels, wood fibers, or tracheids) of the natural wood microstructure. In some embodiments, despite the partial delignification resulting from the first and second chemical treatments, at least some of the walls of the longitudinally-extending cells can remain attached together, while other walls of the longitudinally-extending cells may separate.

The duration of immersion within the respective chemical solution may be a function of the amount of lignin to be removed, size of the wood piece, temperature of the chemical solution, pressure of the treatment, and/or agitation. For example, smaller amounts of lignin removal, smaller piece size, higher solution temperature, higher treatment pressure, and agitation may be associated with shorter immersion times, while larger amounts of lignin removal, larger piece size, lower solution temperature, lower treatment pressure, and no agitation may be associated with longer immersion times. In some embodiments, the first chemical treatment can be omitted in favor of performing only the second chemical treatment (e.g., chemical solution at a temperature of 120-180° C.).

If the second duration has been reached (e.g., t≥t₂), the method 400 can proceed from decision block 410 to process block 412, where rinsing can optionally be performed. For example, the rinsing can be used to remove residual chemicals or particulate(s) resulting from the partial delignification process. For example, the piece of partially-delignified wood can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration.

The method 400 can proceed to process block 414, where the piece of partially-delignified wood can be subjected to drying, for example, such that the moisture content therein is less than 15 wt % (e.g., 8-12 wt %). In some embodiments, the drying can be such that the structures of the longitudinally-extending lumina in the wood microstructure are retained (e.g., with a cross-sectional shape substantially the same as that in the native wood), for example, by avoiding surface-tension-induced collapse or crumpling from evaporation of water. For example, the drying can comprise a freeze-drying process, a critical point drying process, a solvent exchange process, or any combination of the above. For example, the freeze-drying process can include reducing a temperature of the partially delignified cellulose-based material to below a freezing point of the fluid therein (e.g., less than 0° C.), then reducing a pressure to allow the frozen fluid therein to sublime (e.g., less than a few millibars). For example, the critical point drying process can include immersing the partially delignified cellulose-based material in a fluid (e.g., liquid carbon dioxide), increasing a temperature and pressure of the bamboo segment past a critical point of the fluid (e.g., 7.39 MPa, 31.1° C. for carbon dioxide), and then gradually releasing the pressure to remove the now gaseous fluid. For example, the solvent exchange process can include replacing water within the partially-delignified wood with an organic solvent or alcohol (e.g., acetone, ethanol, etc.), which may be more readily evaporated without collapsing the longitudinally-extending lumina.

After the drying, the piece of partially-delignified wood can be elastic (e.g., an elastic wood piece) at least along its tangential direction, for example, due at least in part to removal of ray cells. In some embodiments, the piece of partially-delignified wood can remain inelastic along its radial and longitudinal directions, for example, due at least in part to retention of the longitudinal cells. In such embodiments, the dried piece of partially-delignified wood can exhibit asymmetric elasticity.

The method 400 can proceed to process block 416, where the elastic wood piece can optionally be subjected to one or more modifications. In some embodiments, the optional modification can comprise sealing the elastic wood piece, for example, to prevent ingress of moisture or egress of moisture. For example, the sealing can be by placing the elastic wood piece in a sealed or controlled environment. Alternatively or additionally, the sealing can be achieved by a protective layer or coating provided over exposed surfaces of the elastic wood piece. For example, the protecting layer or coating can be a polyurethane coating, paint, silane hydrophobic coating, or any other coating effective to prevent, or at least restrict, movement of moisture into or out of the wood piece. Alternatively or additionally, the optional modification can include a destructive modification, for example, machining or cutting to prepare the elastic wood piece for subsequent use.

In some embodiments, the optional modification can include applying a coating to external surfaces and/or internal surfaces of the elastic wood piece, and/or coupling particles to the external surfaces and/or internal surfaces of the elastic wood piece. In some embodiments, the coating can have a thickness less than or equal to 10 μm, for example, in a range of 10 nm-10 μm, inclusive. In some embodiments, the coating may be such that the porosity of the elastic wood piece remains at least 50%. In some embodiments, the coating or the coupled particles can include a conductive material, a semiconductive material, or an insulating material. For example, the coating or the coupled particles can include nanoparticles, nanowires, graphene, graphite, ceramic oxide, single-walled carbon nanotubes (CNTs), double-walled CNTs, multi-walled CNTs, polyaniline, carbon black, graphite, hard carbon (e.g., char or non-graphitizing carbon), reduced graphene oxide, graphene, plasmonic metallic nanoparticles, catalytic nanoparticles, electroactive nanoparticles, metal alloy nanoparticles, semiconductor nanoparticles, sulfides, phosphides, borides, oxides, or any combination of the foregoing. Examples of materials for the plasmonic metallic nanoparticles include but are not limited to Au, Pt, Ag, Pd, and Ru. The metallic nanoparticles and the metal alloy nanoparticles can include, but are not limited to, Pt. Pd, Au, Ag, Ni, Co, Ru, and Fe. Examples of materials for the semiconductor nanoparticles include CuFeSe: or any other semiconductor. Examples of materials for the sulfides include, but are not limited to, MoS₂, CoSₓ, and FeS₂, where x is an integer. Examples of materials for the phosphides include, but are not limited to, CoP, NiP₂, and MoPₓ, where x is an integer. Examples of materials for the borides include, but are not limited to, CoB, MoB, and NiB Examples of materials for the oxides include, but are not limited to, MnO₂, Fe₂O₃, CoO, and NiO.

Alternatively or additionally, in some embodiments, the coating can comprise a hydrophobic material, a water-resistant material, a weather-resistant material, or any combination of the foregoing. For example, the coating can comprise manganese oxide polystyrene (MnO₃/PS) nano-composite, zinc oxide polystyrene (ZnO/PS) nano-composite, precipitated calcium carbonate, carbon nanotube structures, silica nano-coating, fluorinated silanes, polyethylene, polystyrene, polyvinylchloride, polytetrafluorethylene, polydimethylsiloxane, polyester, polyurethane, acrylic, epoxy, or any combination of the foregoing. Alternatively or additionally, the coating can comprise sodium chloride, potassium sulphate, sodium sulphate, calcium sulphate, magnesium sulphate, copper sulphate, sodium nitrate, sodium carbonate, calcium, silicon, phosphorus, silver, titanium oxide, or any combination of the foregoing.

In some embodiments, the optional modification can include infiltrating the elastic wood piece with another elastic or flexible material, such as a polymer (or polymer precursor) or protein, so as to form an elastic wood composite. In some embodiments, the material can substantially or at least mostly fill the open lumina of the wood microstructure. In some embodiments, the infiltration may be such that the porosity of the elastic wood composite is reduced to less than or equal to 10%. For example, the elastic or flexible material can be natural or synthetic polyisoprene, polybutadiene, chloroprene rubber (e.g., Baypren®), polychloroprene, neoprene, butyl rubber, halogenated butyl rubber, styrene-butadiene rubber (e.g., copolymer of styrene and butadiene), polydimethylsiloxane (PDMS), nitrile rubber (e.g., copolymer of butadiene and acrylonitrile), hydrogenated nitrile rubber (e.g., Therban®, Zetpol®, etc.), ethylene propylene rubber (e.g., a copolymer of ethene and propene), ethylene propylene diene monomer (EPDM) rubber, epichlorohydrin rubber, polyacrylic rubber, silicon rubber, fluorosilicone rubber, fluoroelastomer (e.g., Viton™, Tecnoflon®, Fluorel™, AFLAS®, DAI-EL™), perfluoroelastomer (e.g., Tecnoflon® PFR, Kalrez®, Chemraz®, Perlast®), polyether block amide, cholorsulfonated polyethylene (e.g., Hypalon®), ethylene-vinyl acetate, thermoplastic elastomer, resilin, elastin, polysulfide rubber, elastolefin, poly(dichlorophosphazene), an inorganic rubber from hexachlorophosphaze polymerization, or any combination of the foregoing.

The method 400 can proceed to process block 418, where the elastic wood piece (or composite) can be used in a particular application or adapted for use in a particular application. In some embodiments, the elastic wood piece (or composite) can be used as an anisotropic resilient structure that can completely recover its original shape after being subjected to a compressive force along its tangential direction (while remaining substantially inelastic along the orthogonal radial and longitudinal directions). In some embodiments, the elastic wood piece (or composite) can be employed as a sound-absorbing or force-absorbing material. In some embodiments, the elastic wood piece can be oriented with its inelastic plane (e.g., along radial and longitudinal directions) to support a force applied to it (e.g., act as a structural member) while its elastic direction (e.g., along the tangential direction) absorbs a force applied to it (e.g., acts as a sound absorbing member).

The elastic wood piece (or composite) can be used in any application where a resilient and/or spongy material may be useful, such as, but not limited to building (construction) or structural materials (e.g., insulation, flooring, etc.), sound absorbers, parts of footwear (e.g., inserts or insoles, outsoles, midsoles, uppers, tongues, etc.), cushioning (e.g., packing materials, mattresses, pillows, cushions, etc.), seals (e.g., gaskets, O-rings, etc.), isolation devices (e.g., damping pad, anti-vibration mounts, etc.), damping elements (e.g., shock absorber), energy storage or harvesting devices, elastic substrates (e.g., flexible conductors, flexible electronic devices, wearable devices, etc.), shape memory structures, and tires. In some embodiments, the elastic wood piece (or composite) can be used as a structural material, for example, assembled together with non-plant materials (e.g., metal, metal alloy, plastic, ceramic, composite, etc.) to form a heterogeneous composite structure.

Although blocks 402-418 in FIG. 4 have been described as being performed once, in some embodiments, multiple repetitions of a particular process block may be employed before proceeding to the next decision block or process block. In addition, although blocks 402-418 in FIG. 4 have been separately illustrated and described, in some embodiments, process blocks may be combined and performed together (simultaneously or sequentially). Moreover, although FIG. 4 illustrates a particular order for blocks 402-418, embodiments of the disclosed subject matter are not limited thereto. Indeed, in certain embodiments, the blocks may occur in a different order than illustrated or simultaneously with other blocks.

### Fabricated Examples and Experimental Results

In a fabricated example, a piece of natural balsa wood with a density of 0.17 g/cm³ was subjected to partial delignification to remove ˜75% of native lignin therein. The piece of balsa wood was immersed in aqueous solution of NaOH for 24 hours at room temperature, after which the temperature of the NaOH solution was increased to 160° C. and maintained for ˜5 hours. After partial-delignification, the balsa wood was freeze-dried to remove moisture therefrom while preserving the open (e.g., uncrumpled) microstructure of the longitudinally-extending cells, as shown in FIGS. 3D-3E. However, the radially-extending ray cells were selectively removed by the partial-delignification, as shown in FIGS. 3B-3D.

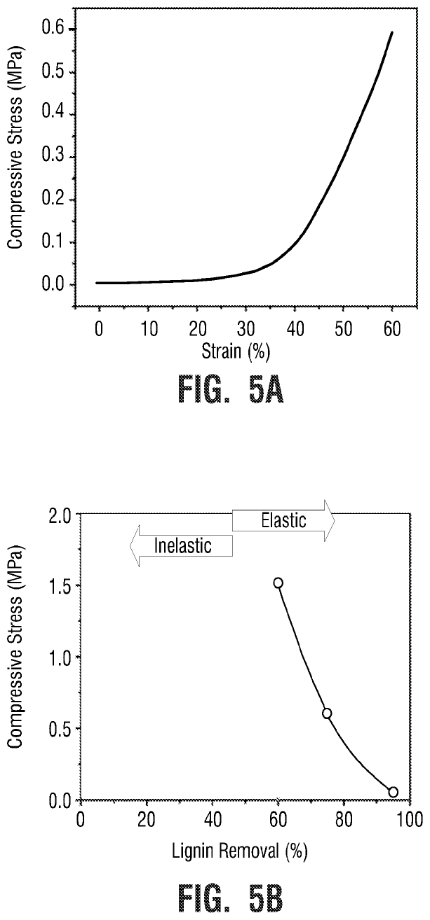

The dried, partially-delignified wood was then subjected to compressive testing, the results of which are shown in FIG. 5A. As is evident from the figure, the partially-delignified wood exhibits a mechanical strength of ˜0.6 MPa under 60% compression in the dry state, which is significantly higher than conventional wood-based aerogels. FIG. 5B further illustrates the dependency of mechanical strength on percent lignin removal. As is evident from the figure, the compressive strength decreases from 1.5 MPa to 0.05 MPa as lignin removal increases from 60% to 95%. However, below ˜45% lignin removal, the resulting structure may remain inelastic. FIG. 7 further illustrates the dependency of compression behavior on chemical solution concentration (where higher concentrations of NaOH can result in greater lignin removal for otherwise the same processing conditions). As is evident from the figure, the elastic behavior of the processed wood can be tailored for a specific application by appropriate selection of chemical solution and processing conditions. For example, in applications where less elasticity is desired (e.g., a stiffer structure), 2.5 wt % NaOH can be used to form a structure that exhibits maximum compressive stress at a strain of about 0.3, while in applications where more elasticity is desired (e.g., a softer structure), 5.0 wt % NaOH can be used to form a structure that exhibits maximum compressive stress at a strain of about 0.55.

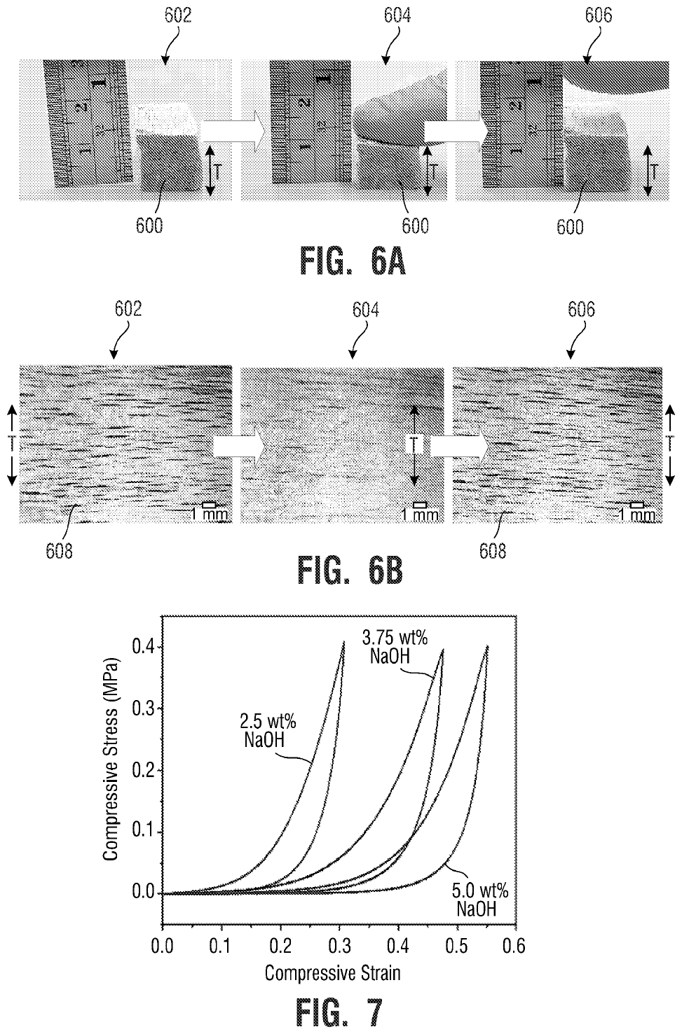

FIGS. 6A-6B show a dried piece of elastic balsa wood 600 undergoing compression cycling, in particular, from an initial stage 602 to a compression stage 604 (e.g., compressed along the tangential direction by about 20% of its original thickness) and then to a recovery stage 606 (e.g., after release of the compression force). The compression cycling was repeated multiple times, with the wood 600 returning to its original shape each time. As shown in FIG. 6B, during the compression stage 604, the voids 608 created by selective removal of ray cells are collapsed by the application of the compression force. However, after removal of the compression force, the voids 608 re-expand in the recovery stage 606, thereby restoring wood 600 to its original shape.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method comprising:
(a) providing a piece of natural wood having a longitudinal direction, a radial direction, and a tangential direction, the natural wood having a microstructure with lumina formed by cell walls of (i) vessels and wood fiber cells or (ii) tracheids, each of the lumina having an axis that extends along the longitudinal direction, the natural wood further having ray cells, each ray cell having an axis that extends along the radial direction, the tangential direction being perpendicular to the longitudinal and radial directions;
(b) immersing at least part of the piece of natural wood in a first solution at a first temperature for a first time, the first temperature being less than 100° C.;
(c) after the immersing of (b), immersing the at least part of the piece of natural wood in a second solution at a second temperature for a second time so as to form a piece of partially-delignified wood, the second temperature being greater than 100° C., wherein the immersing of (b) and the immersing of (c) are effective to remove between 45% and 90%, inclusive, of lignin from the piece of natural wood and destroy a structure of the ray cells in the piece of natural wood while retaining the lumina formed by the cell walls; and
(d) after (c), drying the piece of partially-delignified wood such that the lumina remain open,
wherein, after (d), the piece of partially-delignified wood is substantially elastic along the tangential direction.

Clause 2. The method of any clause or example herein, in particular, Clause 1, wherein, after (d), the piece of partially-delignified wood is substantially inelastic along the radial and longitudinal directions.

Clause 3. The method of any clause or example herein, in particular, any one of Clauses 1-2, wherein the immersing of (b) and the immersing of (c) are effective to remove between 60% and 90%, inclusive, of lignin in the piece of natural wood.

Clause 4. The method of any clause or example herein, in particular, any one of Clauses 1-3, wherein the natural wood is a hardwood, and after (c), a lignin content of the piece of partially-delignified wood is 2-16.5 wt %, inclusive.

Clause 5. The method of any clause or example herein, in particular, any one of Clauses 1-3, wherein the natural wood is a softwood, and after (c), a lignin content of the piece of partially-delignified wood is 2.5-19.2 wt %, inclusive.

Clause 6. The method of any clause or example herein, in particular, any one of Clauses 1-5, wherein, after (d), a moisture content of the piece of partially-delignified wood is less than or equal to 15 wt %.

Clause 7. The method of any clause or example herein, in particular, any one of Clauses 1-6, wherein the first solution and the second solution are the same, and the immersing of (c) comprises heating the first solution from the first temperature to the second temperature.

Clause 8. The method of any clause or example herein, in particular, any one of Clauses 1-7, wherein the first time is greater than or equal to 8 hours, the second time is less than or equal to 10 hours, the first time is less than the second time, or any combination of the foregoing.

Clause 9. The method of any clause or example herein, in particular, any one of Clauses 1-8, wherein the first time is about 8-24 hours.

Clause 10. The method of any clause or example herein, in particular, any one of Clauses 1-9, wherein the second time is 0.1-5 hours, inclusive.

Clause 11. The method of any clause or example herein, in particular, any one of Clauses 1-10, wherein the first temperature is 5-95° C., inclusive, and/or the second temperature is 120-180° C., inclusive.

Clause 12. The method of any clause or example herein, in particular, any one of Clauses 1-11, wherein the first solution, the second solution, or both the first and second solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), or any combination of the foregoing.

Clause 13. The method of any clause or example herein, in particular, any one of Clauses 1-12, wherein the first solution, the second solution, or both are a solution of NaOH.

Clause 14. The method of any clause or example herein, in particular, any one of Clauses 1-13, wherein, after (d), the piece of partially-delignified wood has a compressive strength of at least 0.1 MPa.

Clause 15. The method of any clause or example herein, in particular, any one of Clauses 1-14, wherein, after (d), the piece of partially-delignified wood has a compressive strength of 0.1-1.5 MPa, inclusive, at 60% compression.

Clause 16. The method of any clause or example herein, in particular, any one of Clauses 1-15, further comprising, subjecting the piece of partially-delignified wood to one or more surface treatments.

Clause 17. The method of any clause or example herein, in particular, Clause 16, wherein the one or more surface treatments comprises applying a coating to external surfaces, internal surfaces, or both external and internal surfaces of the piece of partially-delignified wood.

Clause 18. The method of any clause or example herein, in particular, Clause 17, wherein the coating has a thickness of 10 nm to 10 μm, inclusive.

Clause 19. The method of any clause or example herein, in particular, any one of Clauses 17-18, wherein the coating comprises nanoparticles, nanowires, graphene, graphite, ceramic oxide, carbon nanotubes, polyaniline, carbon black, reduced graphene oxide, graphene, or any combination of the foregoing.

Clause 20. The method of any clause or example herein, in particular, any one of Clauses 17-19, wherein the coating comprises a hydrophobic material, a water-resistant material, a weather-resistant material, or any combination of the foregoing.

Clause 21. The method of any clause or example herein, in particular, any one of Clauses 17-20, wherein the coating comprises manganese oxide polystyrene (MnO₃/PS) nano-composite, zinc oxide polystyrene (ZnO/PS) nano-composite, precipitated calcium carbonate, carbon nanotube structures, silica nano-coating, fluorinated silanes, polyethylene, polystyrene, polyvinylchloride, polytetrafluorethylene, polydimethylsiloxane, polyester, polyurethane, acrylic, epoxy, or any combination of the foregoing.

Clause 22. The method of any clause or example herein, in particular, any one of Clauses 17-21, wherein the coating comprises anti-bacterial salt or metal particles.

Clause 23. The method of any clause or example herein, in particular, any one of Clauses 17-22, wherein the coating comprises sodium chloride, potassium sulphate, sodium sulphate, calcium sulphate, magnesium sulphate, copper sulphate, sodium nitrate, sodium carbonate, calcium, silicon, phosphorus, silver nanoparticles, titanium oxide nanoparticles, or any combination of the foregoing.

Clause 24. The method of any clause or example herein, in particular, any one of Clauses 17-23, wherein the coating comprises plasmonic metallic nanoparticles, catalytic nanoparticles, electroactive nanoparticles, or any combination of the foregoing.

Clause 25. The method of any clause or example herein, in particular, any one of Clauses 16-24, wherein, after the one or more surface treatments, the piece of partially-delignified wood has a porosity of at least 50%.

Clause 26. The method of any clause or example herein, in particular, any one of Clauses 1-25, further comprising, filling the open lumina of the piece of partially-delignified wood with a natural or synthetic polymer.

Clause 27. The method of any clause or example herein, in particular, Clause 26, wherein, after the filling, the piece of partially-delignified wood has a porosity of less than or equal to 10%.

Clause 28. The method of any clause or example herein, in particular, any one of Clauses 1-27, wherein, after (d), a modulus of elasticity of the piece of partially-delignified wood along the tangential direction is at least an order of magnitude less than that along the radial direction or that along the longitudinal direction.

Clause 29. The method of any clause or example herein, in particular, any one of Clauses 1-28, wherein the drying of (d) comprises freeze drying, critical point drying, solvent exchange, or any combination of the foregoing.

Clause 30. The method of any clause or example herein, in particular, any one of Clauses 1-29, further comprising, after (d), arranging the piece of partially-delignified wood in or as part of a structure such that a force applied to the structure is directed substantially along the tangential direction.

Clause 31. The method of any clause or example herein, in particular, Clause 30, wherein the structure is footwear.

Clause 32. A wood structure formed by the method of any clause or example herein, in particular, any one of Clauses 1-31.

Clause 33. A wood structure comprising:
a piece of partially-delignified wood that retains lumina formed by cell walls of (i) vessels and wood fiber cells or (ii) tracheids from an original natural wood but lacks ray cells from the original natural wood, each of the lumina having an axis that extends along a longitudinal direction of the natural wood, each ray cell having an axis that extends along a radial direction of the natural wood,
wherein a tangential direction of the natural wood is perpendicular to the longitudinal and radial directions, and
the piece of partially-delignified wood is substantially elastic along the tangential direction.

Clause 34. The wood structure of any clause or example herein, in particular, any one of Clause 32-33, wherein the piece of partially-delignified wood is substantially inelastic along the radial and longitudinal directions.

Clause 35. The wood structure of any clause or example herein, in particular, any one of Clauses 32-34, wherein a lignin content of the piece of partially-delignified wood is reduced by 45-90%, inclusive, as compared to that of the original natural wood.

Clause 36. The wood structure of any clause or example herein, in particular, any one of Clauses 32-35, wherein a lignin content of the piece of partially-delignified wood is reduced by 60-90%, inclusive, as compared to that of the original natural wood.

Clause 37. The wood structure of any clause or example herein, in particular, any one of Clauses 32-36, wherein the natural wood is a hardwood, and a lignin content of the piece of partially-delignified wood is 2-16.5 wt %, inclusive.

Clause 38. The wood structure of any clause or example herein, in particular, any one of Clauses 32-36, wherein the natural wood is a softwood, and a lignin content of the piece of partially-delignified wood is 2.5-19.2 wt %, inclusive.

Clause 39. The wood structure of any clause or example herein, in particular, any one of Clauses 32-38, wherein a moisture content of the piece of partially-delignified wood is less than or equal to 15 wt %.

Clause 40. The wood structure of any clause or example herein, in particular, any one of Clauses 32-39, wherein the piece of partially-delignified wood has a compressive strength of at least 0.1 MPa

Clause 41. The wood structure of any clause or example herein, in particular, any one of Clauses 32-40, wherein the piece of partially-delignified wood has a compressive strength of 0.1-1.5 MPa, inclusive, at 60% compression.

Clause 42. The wood structure of any clause or example herein, in particular, any one of Clauses 32-41, further comprising a coating on external surfaces, internal surfaces, or both external and internal surfaces of the piece of partially-delignified wood.

Clause 43. The wood structure of any clause or example herein, in particular, Clause 42, wherein the coating has a thickness of 10 nm to 10 μm, inclusive.

Clause 44. The wood structure of any clause or example herein, in particular, any one of Clauses 42-43, wherein the coating comprises nanoparticles, nanowires, graphene, graphite, ceramic oxide, carbon nanotubes, polyaniline, carbon black, reduced graphene oxide, graphene, or any combination of the foregoing.

Clause 45. The wood structure of any clause or example herein, in particular, any one of Clauses 42-44, wherein the coating comprises a hydrophobic material, a water-resistant material, a weather-resistant material, or any combination of the foregoing.

Clause 46. The wood structure of any clause or example herein, in particular, any one of Clauses 42-45, wherein the coating comprises manganese oxide polystyrene (MnO₃/PS) nano-composite, zinc oxide polystyrene (ZnO/PS) nano-composite, precipitated calcium carbonate, carbon nanotube structures, silica nano-coating, fluorinated silanes, polyethylene, polystyrene, polyvinylchloride, polytetrafluorethylene, polydimethylsiloxane, polyester, polyurethane, acrylic, epoxy, or any combination of the foregoing.

Clause 47. The wood structure of any clause or example herein, in particular, any one of Clauses 42-46, wherein the coating comprises anti-bacterial salt or metal particles.

Clause 48. The wood structure of any clause or example herein, in particular, any one of Clauses 42-47, wherein the coating comprises sodium chloride, potassium sulphate, sodium sulphate, calcium sulphate, magnesium sulphate, copper sulphate, sodium nitrate, sodium carbonate, calcium, silicon, phosphorus, silver nanoparticles, titanium oxide nanoparticles, or any combination of the foregoing.

Clause 49. The wood structure of any clause or example herein, in particular, any one of Clauses 42-48, wherein the coating comprises plasmonic metallic nanoparticles, catalytic nanoparticles, electroactive nanoparticles, or any combination of the foregoing.

Clause 50. The wood structure of any clause or example herein, in particular, any one of Clauses 32-49, wherein the piece of partially-delignified wood has a porosity of at least 50%.

Clause 51. The wood structure of any clause or example herein, in particular, any one of Clauses 32-49, further comprising a natural or synthetic polymer disposed within or filling open lumina of the piece of partially-lignified wood.

Clause 52. The wood structure of any clause or example herein, in particular, Clause 51, wherein the piece of partially-delignified wood has a porosity less than or equal to 10%.

Clause 53. The wood structure of any clause or example herein, in particular, any one of Clauses 32-52, wherein a modulus of elasticity of the piece of partially-delignified wood along the tangential direction is at least an order of magnitude less than that along the radial direction or that along the longitudinal direction.

Clause 54. The wood structure of any clause or example herein, in particular, any one of Clauses 32-53, wherein the piece of partially-delignified wood is arranged such that an applied force is directed substantially along the tangential direction.

Clause 55. The wood structure of any clause or example herein, in particular, any one of Clauses 32-54, wherein the structure is formed as footwear.

Clause 56. The wood structure of any clause or example herein, in particular, any one of Clauses 32-55, wherein the piece consists essentially of the partially-delignified wood.

### CONCLUSION

Any of the features illustrated or described herein, for example, with respect to FIGS. 3A-7 and Clauses 1-56, can be combined with any other feature illustrated or described herein, e.g., with respect to FIGS. 3A-7 and Clauses 1-56 to provide wood materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
(a) providing a piece of natural wood having a longitudinal direction, a radial direction, and a tangential direction, the natural wood having a microstructure with lumina formed by cell walls of (i) vessels and wood fiber cells or (ii) tracheids, each of the lumina having an axis that extends along the longitudinal direction, the natural wood further having ray cells, each ray cell having an axis that extends along the radial direction, the tangential direction being perpendicular to the longitudinal and radial directions;
(b) immersing at least part of the piece of natural wood in a first solution at a first temperature for a first time, the first temperature being less than 100° C.;
(c) after the immersing of (b), immersing the at least part of the piece of natural wood in a second solution at a second temperature for a second time so as to form a piece of partially-delignified wood, the second temperature being greater than 100° C., wherein the immersing of (b) and the immersing of (c) are effective to remove between 45% and 90%, inclusive, of lignin from the piece of natural wood and destroy a structure of the ray cells in the piece of natural wood while retaining the lumina formed by the cell walls; and
(d) after (c), drying the piece of partially-delignified wood such that the lumina remain open,
wherein, after (d), the piece of partially-delignified wood is substantially elastic along the tangential direction and substantially inelastic along the radial and longitudinal directions.

2-4. (canceled)

5. The method of claim 1, wherein, after (d), a moisture content of the piece of partially-delignified wood is less than or equal to 15 wt %.

6. (canceled)

7. The method of claim 1, wherein the first time is greater than or equal to 8 hours, and the second time is less than or equal to 10 hours.

8-9. (canceled)

10. The method of claim 1, wherein the first temperature is 5-95° C.,
inclusive, and/or the second temperature is 120-180° C., inclusive.

11. The method of claim 1, wherein the first solution, the second solution, or both the first and second solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), or any combination of the above.

12-14. (canceled)

15. The method of claim 1, further comprising, subjecting the piece of partially-delignified wood to one or more surface treatments.

16. The method of claim 15, wherein the one or more surface treatments comprises applying a coating to external surfaces, internal surfaces, or both external and internal surfaces of the piece of partially-delignified wood, and the coating has a thickness of 10 nm to 10 μm, inclusive.

17-23. (canceled)

24. The method of claim 15, wherein, after the one or more surface treatments, the piece of partially-delignified wood has a porosity of at least 50%.

25. The method of claim 1, further comprising, filling the open lumina of the piece of partially-delignified wood with a natural or synthetic polymer, wherein, after the filling, the piece of partially-delignified wood has a porosity of less than or equal to 10%.

26. (canceled)

27. The method of claim 1, wherein, after (d), a modulus of elasticity of the piece of partially-delignified wood along the tangential direction is at least an order of magnitude less than that along the radial direction or that along the longitudinal direction.

28. (canceled)

29. The method of claim 1, further comprising, after (d), arranging the piece of partially-delignified wood in or as part of a structure such that a force applied to the structure is directed substantially along the tangential direction.

30-31. (canceled)

32. A wood structure comprising:
a piece of partially-delignified wood that retains lumina formed by cell walls of (i) vessels and wood fiber cells or (ii) tracheids from an original natural wood but lacks ray cells from the original natural wood, each of the lumina having an axis that extends along a longitudinal direction of the natural wood, each ray cell having an axis that extends along a radial direction of the natural wood,
wherein a tangential direction of the natural wood is perpendicular to the longitudinal and radial directions, and
the piece of partially-delignified wood is substantially elastic along the tangential direction and substantially inelastic along the radial and longitudinal directions.

33-34. (canceled)

35. The wood structure of claim 32, wherein:
the natural wood is a hardwood, and a lignin content of the piece of partially-delignified wood is 2-16.5 wt %, inclusive; or
the natural wood is a softwood, and a lignin content of the piece of partially-delignified wood is 2.5-19.2 wt %, inclusive.

36. (canceled)

37. The wood structure of claim 32, wherein a moisture content of the piece of partially-delignified wood is less than or equal to 15 wt %.

38. (canceled)

39. The wood structure of claim 32, wherein the piece of partially-delignified wood has a compressive strength of 0.1-1.5 MPa, inclusive, at 60% compression.

40. The wood structure of claim 32, further comprising a coating on external surfaces, internal surfaces, or both external and internal surfaces of the piece of partially-delignified wood, wherein the coating has a thickness of 10 nm to 10 μm, inclusive.

41-47. (canceled)

48. The wood structure of claim 40, wherein the piece of partially-delignified wood has a porosity of at least 50%.

49. The wood structure of claim 32, further comprising a natural or synthetic polymer disposed within or filling open lumina of the piece of partially-lignified wood, wherein the piece of partially-delignified wood has a porosity less than or equal to 10%.

50. (canceled)

51. The wood structure of claim 32, wherein a modulus of elasticity of the piece of partially-delignified wood along the tangential direction is at least an order of magnitude less than that along the radial direction or that along the longitudinal direction.

52. (canceled)

53. The wood structure of claim 32, wherein the structure is formed as footwear.

54. (canceled)
